(19) United States
(12) Patent Application Publication
(10) Pub. No.: US 2026/0087229 A1
(43) Pub. Date: Mar. 26, 2026

(54) PLATFORM FOR ARTIFACT GENERATION USING A TRAINED NEURAL NETWORK

(71) Applicant: ExlService Holdings, Inc., New York, NY (US)

(72) Inventors: Manbir Singh, Edison, NJ (US); Diptojeet Mukhopadhyay, Kolkata (IN); Ishan Tripathi, Greater Noida (IN); Sourabh Tiwari, Greater Noida (IN); Pavan Praneeth, Hyderabad (IN); Sumalakshmi Subhash, Thanisandra (IN); Sumit Taneja, Jersey City, NJ (US)

(21) Appl. No.: 18/898,437

(22) Filed: Sep. 26, 2024

(51) Int. Cl. G06F 40/10; G06F 16/438; G06N 3/0475; G06V 20/40

(52) U.S. Cl. CPC G06F 40/10; G06F 16/438; G06N 3/0475; G06V 20/46

(57) ABSTRACT

An artifact generation platform can generate project artifacts by implementing extended context windows on an artificial intelligence model (e.g., a trained neural network). Project artifacts can be generated by processing a set of files (e.g., transcript, audio recording, video recording, audiovisual recording) to extract or generate transcript and/or context tokens. Using user-provided output type instructions and the tokens, a trained neural network can generate a project artifact according to the specific output type and context (e.g., project type, user role, domain, technology stack descriptor). The platform can include a chat bot to enable users to query the project artifact and/or cause computer systems to perform automatic actions using the generated project artifact.

### TECHNICAL FIELD

The systems, methods, and computer-readable media disclosed herein relate generally to automatically generating complex project artifacts using a trained neural network. More particularly, the systems, methods, and computer-readable media can implement techniques for increasing the native context window of the trained neural network. In some use cases, the techniques can include automatically identifying and completing computer-executable tasks, using the neural network output, during a query and response session with a chat bot.

### BACKGROUND

Project artifacts can be thought of as structured documents that capture information, decisions, and requirements related to a project. Project artifacts can be used as formal records and communication tools that help users understand the project's scope, progress, and deliverables. Common types of project artifacts include call summaries, which document key points and action items from meetings or calls; meeting minutes, which provide a record of discussions and decisions made during meetings; user stories, which describe features or functionalities from the end-user's perspective; test cases, which outline the conditions and/or steps for testing specific functionalities; business requirements documents, which detail the business needs and objectives that the project aims to fulfill; and process steps, which define the sequence of activities required to complete a task or process.

Generating project artifacts can present challenges due to the inherent diversity in communication tools and platforms that provide input data regarding various project aspects. Such data can include audiovisual files—for example, recordings of brainstorming sessions, project planning sessions, idea harvesting sessions, requirements discussion, stakeholder meetings, and the like. The data can also include documents and real-time communications through voice, messaging, email, text, and the like. Synthesizing information from audiovisual data can be difficult to execute because audiovisual data contains both visual and auditory components to be synchronized. Additionally, ensuring that the extracted portions are contextually relevant to specific artifact types (e.g., requirements definitions, project charters), project types, user roles, domains, and technology stacks can add a further layer of complexity. A particular project context may have a unique set of task dependencies, terminologies, and standards. For instance, a project artifact for a software development project may differ significantly from a project artifact for a regulatory compliance project. Further, when particular resources such as personnel, budget, or equipment are reallocated, the reallocation can impact varying aspects of the project, such as task timelines, deliverable schedules, and overall project milestones. Reallocations may necessitate updates to various artifacts, such as project plans, user stories, or resource management documents to accurately reflect the new allocation, which can be difficult due to complex interdependencies.

### BRIEF DESCRIPTION OF THE DRAWINGS

FIG. 1 shows an example computing environment that includes an artifact generation platform in accordance with some implementations of the present technology.

FIG. 2 shows an example architecture of an application supporting the artifact generation platform in accordance with some implementations of the present technology.

FIG. 3A shows an example graphical user interface (GUI) that demonstrates aspects of an instruction interface of the artifact generation platform in accordance with some implementations of the present technology.

FIG. 3B shows an example GUI that demonstrates aspects of a filter interface of the artifact generation platform in accordance with some implementations of the present technology.

FIG. 3C shows an example GUI that demonstrates aspects of an output display interface of the artifact generation platform in accordance with some implementations of the present technology.

FIG. 3D shows an example GUI that demonstrates aspects of a chat bot interface of the artifact generation platform in accordance with some implementations of the present technology.

FIG. 3E shows an example GUI that demonstrates aspects of a regeneration interface of the artifact generation platform in accordance with some implementations of the present technology.

FIG. 3F shows an example GUI that demonstrates aspects of an artifact management interface of the artifact generation platform in accordance with some implementations of the present technology.

FIG. 4 is a flowchart depicting an example method of operation of the artifact generation platform of FIG. 1, in accordance with some implementations of the present technology.

FIG. 5 illustrates a layered architecture of an artificial intelligence (AI) system that can implement the machine learning models of the artifact generation platform of FIG. 1, in accordance with some implementations of the present technology.

FIG. 6 is a block diagram showing some of the components typically incorporated in at least some of the computer systems and other devices on which the artifact generation platform operates in accordance with some implementations of the present technology.

FIG. 7 is a system diagram illustrating an example of a computing environment in which the artifact generation platform operates in some implementations of the present technology.

The drawings have not necessarily been drawn to scale. For example, some components and/or operations may be separated into different blocks or combined into a single block for the purposes of discussion of some of the implementations of the disclosed system. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents and alternatives falling within the scope of the technology as defined by the appended claims.

### DETAILED DESCRIPTION

Conventional artifact generation techniques can rely on manual processes and basic automation to compile and format information from various sources, including documents, emails, and real-time communications. In conventional methods, users typically manually input data, transcribe audio recordings, and/or analyze video content to generate the desired artifacts. Although certain conventional platforms can offer templates and standardized formats to help structure the information, the process of extracting and synthesizing the information is largely manual. The manual extraction process not only slows down the documentation process but also increases the likelihood of inconsistencies and omissions in the generated artifacts. Moreover, the manual nature of conventional artifact generation means that the quality and completeness of the project artifacts are highly dependent on the subjective beliefs of the particular user. Each user brings their own perspective, experience, and understanding, which can lead to significant variability in the resulting artifacts. For instance, one user may prioritize certain details or interpret the importance of specific information differently than another user, resulting in inconsistencies across artifacts generated by different individuals. The subjectivity can lead to gaps in the generated artifacts, where information can be overlooked or misrepresented. Additionally, conventional artifact generation approaches can present further challenges during large projects or those with frequent updates, as it becomes increasingly difficult to keep the artifacts current and accurate. This can result in outdated or incorrect information being circulated among users, leading to misunderstandings and potential project delays.

Further, conventional approaches can struggle with the complexity introduced by changes in resource allocation and the complex interdependencies inherent in project management. When resources such as personnel, budget, or equipment are reallocated, the reallocation can trigger a cascade of adjustments across various project dimensions, including task timelines, deliverable schedules, and overall project milestones. Traditional methods struggle to keep up with these dynamic changes, often requiring manual updates to multiple artifacts such as project plans, user stories, and/or resource management documents. The manual process is prone to errors and inconsistencies, making it difficult to recalibrate dependencies, update timelines, and redistribute resources efficiently. Furthermore, conventional approaches may fail to propagate these updates across all relevant artifacts and/or communicate them to relevant users.

Artificial intelligence/machine learning (AI/ML) are instrumental in generating project artifacts. However, AI models, especially when dealing with large prompts, tend to focus disproportionately on the beginning of the prompt and/or the document corpus, and thus may neglect important information that appears later in the prompt and/or the document corpus. Weighing portions differently can lead to incomplete or skewed project artifacts that do not fully capture the intended content. For example, when generating a project artifact such as meeting minutes, an AI model may fail to adequately document decisions and action items discussed in the middle of the meeting, leading to misunderstandings and potential project delays. Additionally, AI/ML models are prone to hallucination. Hallucinations in AI/ML models occur due to limitations in training data, overgeneralization, context window constraints, lack of real-world understanding, ambiguous prompts, and/or inadequate fine-tuning, leading to the generation of plausible but factually incorrect or fabricated information. Hallucinations can be particularly problematic in contexts that rely on high precision and reliability, such as legal documents, technical reports, and/or financial analyses.

In particular, a technical problem of limited context windows can limit AI/ML utility in generating complex project artifacts. By default, AI/ML artifact generation platforms can have restricted output context windows (e.g., restricted to a particular number of tokens, such as 4,096 tokens), which can limit the amount of information that can be processed and generated. Because the context window is limited, AI/ML based systems can struggle to maintain coherence across interactions, understand complexities (e.g., have difficulty grasping connections between various aspects of an input document or dataset), and suffer from hallucinations (e.g., by inventing inaccurate information to fill the gaps).

Generation of project artifacts necessitates the ability to process a large volume of information (e.g., a multi-hour recorded meeting) and reconcile information from different sources. One way to do this in systems with limited context windows is retrieval-augmented generation (RAG), but this technique alone may not be sufficient for generating complex project artifacts because ontologies for generating project artifacts may not be available in advance. In some use cases, the ontologies are generated or supplemented at the time of artifact generation because project-specific terms, requirements, constraints and so forth may be unique to specific projects. For example, a preexisting ontology that defines a set of general principles for systems design may not be applicable to a specific systems design project that has unique constraints (e.g., engineering constraints, time constraints, budget constraints) that can modify, adapt, or supersede the general principles. Even where RAG is appropriate, utilizing RAG techniques to access previously stored data can increase the number of disk read/write operations.

Disclosed herein are systems, methods, and computer-readable media for automatically generating project artifacts using a trained neural network (hereinafter the “artifact generation platform”), which can have an extended context window.

The techniques described herein reduce inconsistencies, omissions, and hallucinations in generating project artifacts and can generate project artifacts more efficiently. By converging information from diverse data sources, such as documents, emails, audio recordings, and/or video files, into a unified set of tokens capable of being processed using extended context windows, the artifact generation platform can ensure that the generated artifacts are accurate, comprehensive, and independent of individual user biases. The use of a trained neural network to generate contextually relevant artifacts based on specific output types and contextual descriptors (such as project type, user role, domain, and technology stack) ensures that the generated artifacts are not only accurate but also contextually relevant. The contextual understanding enables the artifact generation platform to tailor the artifacts to the specific needs of different projects and users. Further, when resources such as personnel, budget, or equipment are reallocated, the artifact generation platform can automatically recalculate dependencies, update timelines, execute notification actions, and redistribute resources, ensuring that all project artifacts reflect the new allocation accurately.

To better improve accuracy and reduce hallucinations in the generated artifacts, the artifact generation platform enables various additional technical advantages by, for example, scoring tokens (e.g., word/phrase in a transcript/audio file, object in a video frame/image) within the input (e.g., a transcript, audio recording, audiovisual file) systematically based on a particular token's relevance/alignment with particular attributes of the project artifact. The scoring system can prioritize the received input, and ensure that the generated artifacts accurately reflect the intended content and context and maintain a balanced attention across the entire prompt.

Further, the artifact generation platform can extend context windows by auto-completing responses (e.g., portions of generated artifacts, also referred to as intermediate outputs), which can significantly extend the output capacity of conventional large language models (LLMs). For example, when the artifact generation platform detects that the size (e.g., byte size, number of tokens, number of characters) a particular output set reaches a certain token limit (e.g., an LLM-native limit, such as 4,096 tokens), the artifact generation platform can automatically resend the context or send an updated context (e.g., output type instruction, project type instruction, user role instruction, knowledge domain instruction, technology stack descriptor/instruction), along with the existing information (for example, intermediate output generated so far) to the LLM to continue generating the artifact. The iterative process ensures that the context is continuously maintained and updated throughout the artifact generation process, thereby extending the LLM-native context window and increasing artifact accuracy. The outputs, including intermediate outputs, can be cached, which reduces the number of disk read and write operations in generating complex project artifacts that may need intermediate output sets. Furthermore, the ability to auto-complete responses with an extended token capacity ensures that the generated artifacts are not fragmented or disjointed. By maintaining a continuous context throughout the generation process, the platform can produce artifacts that are coherent and logically structured.

In some implementations, the artifact generation platform can be implemented in relation to chat bots for project management. For example, the artifact generation platform can be used to generate and display project artifacts during a query and response session with the chat bot. In some implementations, the artifact generation platform receives a set of files, which can include a transcript, a video recording, an audio recording, and/or an audiovisual recording. Using the set of files, the artifact generation platform can generate a set of tokens for a project artifact. A graphical user interface (GUI) can be used to capture an output type instruction (e.g., instructions to generate a call summary, meeting minutes, a user story, a test case, a business requirements document, process steps). Using the output type instruction and the set of tokens, a trained neural network of the artifact generation platform generates the project artifact according to the specific output type. The project artifact can include, for example, a body of text and describe a project type, a user role, a domain, and/or a technology stack. The GUI can generate and display the project artifact and a chat bot, with the context for the chat bot set to the project artifact. When a user query is detected, the chat bot can search the project artifact to provide the user with relevant information regarding the automatically generated project artifact. In some implementations, the chat bot can automatically perform computer-executable tasks using items from the generated project artifacts. The tasks can include, for example, automatically generating hyperlinks and/or application programming interface (API) calls to post the artifacts to downstream systems (e.g., project management systems) and including in the hyperlinks and/or API calls project identifiers, user identifiers, project phase data, or other information from the generated artifacts.

While the current description provides examples related to neural networks, one of skill in the art would understand that the disclosed techniques can apply to other forms of machine learning or algorithms, including unsupervised, semi-supervised, supervised, and reinforcement learning techniques. For example, the disclosed artifact generation platform can generate project artifacts using support vector machine (SVM), k-nearest neighbor (KNN), decision-making, linear regression, random forest, naïve Bayes, or logistic regression algorithms, and/or other suitable computational models.

### Example Implementations of an Artifact Generation Platform

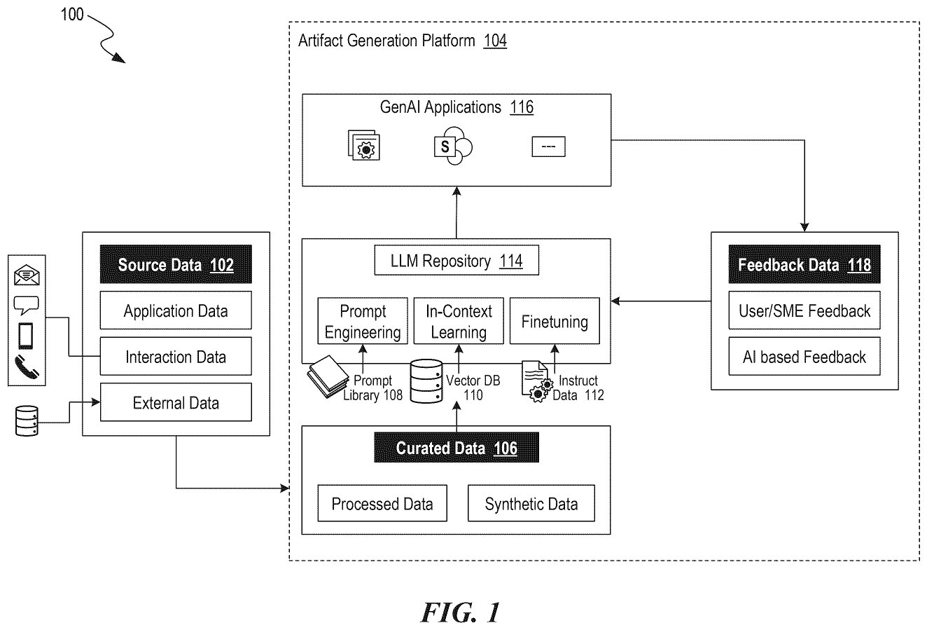

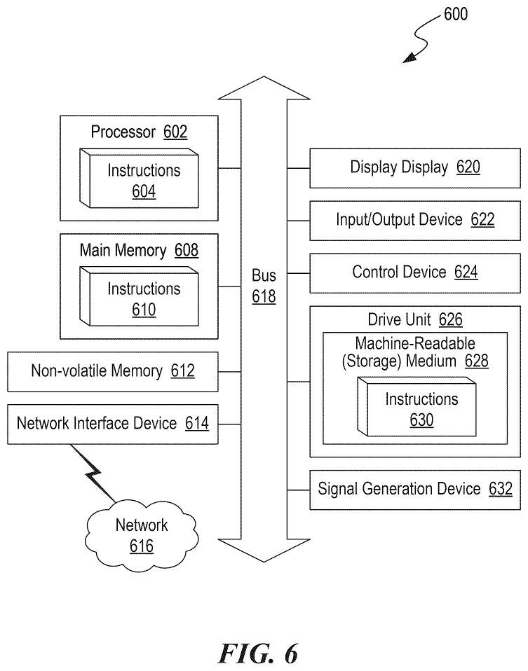

FIG. 1 shows an example computing environment 100 that includes an artifact generation platform 104 in accordance with some implementations of the present technology. Computing environment 100 includes source data 102, artifact generation platform 104, curated data 106, prompt library 108, vector database 110, instruction engine 112, large language model (LLM) repository 114, generative AI applications 116, and feedback data 118. Artifact generation platform 104 is implemented using components of the example computer system 600 illustrated and described in more detail with reference to FIG. 6. Implementations of example environment 100 can include different and/or additional components or can be connected in different ways.

Source data 102 refers to the input data that the artifact generation platform 104 ingests and can be input by, for example, a user, or automatically uploaded by a third-party application (e.g., directly sent to the artifact generation platform 104 after a virtual meeting on a third-party application concludes). Source data 102 data can include application data, interaction data, and/or external data from structured databases. For example, application data can include information generated by various software applications, such as logs, user activities, and/or system events. Interaction data can include communication records such as phone call recordings, SMS messages, and email exchanges. External data from structured databases can refer to organized data sets from external sources, such as customer relationship management (CRM) systems, enterprise resource planning (ERP) systems, and other databases that store structured information relevant to the project. In some implementations, the source data 102 can include unstructured data and real-time data from live feeds. Unstructured data can refer to information that does not have a predefined data model, such as text documents, social media posts, and multimedia content. Real-time data from live feeds can include streaming data from sources such as IoT devices, social media platforms, and live video feeds.

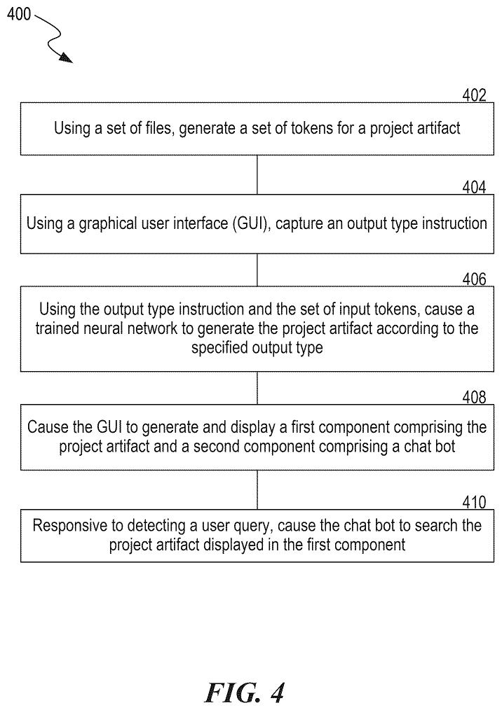

In some implementations, the source data 102 is pre-processed to detect start and end frames, and tokens are generated from the subset of frames between and including these start and end frames using methods discussed with reference to FIG. 4. Tokens can be thought of as discrete units of data that represent elements of the input, such as words (e.g., within a transcript), phrases, objects (e.g., within video frame or image), action (e.g., person speaking), and so forth. In some implementations, the pre-processing can include data quality monitoring, standardization, and/or bias mitigation to enhance the quality of the extracted tokens and/or raw source data 102. Methods of pre-processing source data 102 are discussed in further detail with reference to FIG. 4.

The artifact generation platform 104 uses the pre-processed source data 102 (i.e., curated data 104) to create project artifacts. For example, a user can use the artifact generation platform 104 to process hour-long discussions with business teams and stakeholders to generate business requirements documents (BRDs) and user story documents to automatically and dynamically capture the problem statement and business solution. Project artifacts can be thought of as the outputs produced by the artifact generation platform 104, which can include various types of documentation such as call summaries, meeting minutes, user stories, test cases, BRDs, and/or process steps. In some implementations, the artifact generation platform 104 can generate visual aids such as flowcharts, diagrams, and infographics to complement the textual artifacts. The artifact generation platform 104 can further integrate multiple subsystems (e.g., LLM repository 114, generative AI applications 116) and can include modules for natural language processing, machine learning, and data visualization.

Once the artifact generation platform 104 processes the source data 102, the artifact generation platform 104 refines the data into curated data 106. The artifact generation platform 104 uses the tokens in curated data 106 to indicate the relevance of the source data 102 by assigning relevance scores based on factors such as user role, domain, and/or technology stack descriptor, using methods discussed with reference to FIG. 4. In some implementations, the relevance scores can consider historical data, user preferences, and/or project-specific criteria so that the generated artifacts are tailored to the specific needs of the project and the users involved. The artifact generation platform 104 can store the curated data 106 in a structured format, such as a relational database, to facilitate efficient retrieval. Additionally, in some implementations, the curated data 106 can generate synthetic data created from the LLM repository 114 to enhance the dataset using methods discussed with reference to FIG. 4. Synthetic data refers to artificially generated data that mimics real-world data, used to augment the training dataset and improve model performance. By incorporating synthetic data, the platform can address data scarcity issues, balance class distributions, and introduce variability that helps the model generalize better to unseen data.

The artifact generation platform 104 uses the curated data 106 in the prompt library 108 to guide the artifact generation process. Prompt library 108 is a repository of predefined prompts that guide the artifact generation process. The predefined prompts can capture at least a portion of the output type instructions. For example, the predefined prompts can include the specific requirements for a user story (e.g., a definition of what a user story is, the format of a user story). In some implementations, the prompt library 108 can include customizable templates that enable users to define their own prompts based on specific project requirements. The prompt library 108 can be organized into categories and subcategories to facilitate easy navigation and selection by the users. For example, a business analyst uses the prompt library 108 to generate a business requirements document by selecting relevant prompts and customizing the prompts to fit the project's needs.

The artifact generation platform 104 can convert the curated data 106 and/or the prompts from prompt library 108 into vector representations using the vector database 110 using methods discussed with reference to FIG. 4, to enable a neural network (or any other type of model) to understand the context and relationships between different pieces of information. Vector database 110 stores the vector representations of the tokens generated in the curated data 106. In some implementations, the vector database 110 can support multiple vectorization techniques, such as word embeddings, sentence embeddings, and document embeddings, to capture different levels of semantic information. The vector database 110 ensures that the generated project artifacts are contextually accurate and relevant to the input data. The vector database 110 is part of the LLM repository 114 and is used for in-context learning, which enables models within the LLM repository 114 to generate responses based on the context provided by the input data. In-context learning refers to the model's ability to use the surrounding text and information to generate more accurate and relevant responses.

The instruction engine 112 can interpret the vector representations stored in the vector database 110, guiding the neural network in generating the project artifacts. Instruction engine 112 interprets the output type instructions captured by the prompt library 108 and guides the neural network in generating the project artifacts. The instruction engine 112 can ensure that the generated artifacts align with the specific output type and include the necessary contextual information such as project type, user role, domain, or technology stack descriptor. In some implementations, the instruction engine 112 can incorporate rule-based logic, heuristics, and machine learning models to enhance its decision-making capabilities. The instruction engine 112 can support real-time adjustments based on user feedback and changing project requirements.

The instruction engine 112 utilizes the models stored in the LLM repository 114 to generate the project artifacts using methods discussed with reference to FIG. 4. LLM repository 114 contains the LLMs that the artifact generation platform 104 uses to generate the project artifacts. These LLMs are trained on large amounts of data and are capable of understanding complex language patterns and generating high-quality text. In some implementations, the LLM repository 114 can include multiple models specialized for different domains, languages, and tasks. The LLM repository 114 ensures that the artifact generation platform 104 can produce accurate and contextually relevant outputs. The LLM repository 114 can be regularly updated with new models and training data. The LLM repository 114, in some implementations, evaluates the models for transparency and differential privacy before sending the outputs to the generative AI applications 116. Transparency involves making the model's decision-making process understandable to users, while differential privacy ensures that the model's outputs do not reveal sensitive information about the training data. For example, a healthcare provider uses the artifact generation platform 104 to generate patient summaries and treatment plans while ensuring patient data privacy and compliance with regulations.

The generative AI applications 116 can use the outputs generated by the LLM repository 114 to provide various tools and features for managing project documentation. Generative AI applications 116 can be thought of as the various applications and tools that use the capabilities of the artifact generation platform 104 to produce project artifacts. The generative AI applications 116 can be integrated with third-party software and services (e.g., SALESFORCE, SHAREPOINT). For instance, a third-party software can use the outputs from the LLM repository 114 to automatically generate detailed customer interaction summaries, sales reports, and predictive analytics. By incorporating the outputs from the LLM repository 114, these third-party applications can significantly improve efficiency, accuracy, and productivity in various processes.

The generative AI applications 116 can provide feedback data 118 that can be used for bias monitoring, data lineage, and LLM tracking for the LLM repository 114. Feedback data 118 represents the user feedback collected on the generated project artifacts. Bias monitoring includes assessing the outputs generated by the AI models to identify and mitigate any biases that may be present, as biases can lead to skewed or discriminatory results. The feedback data 118 collected from generative AI applications 116 can include user feedback, performance metrics, and anomaly detection reports, which help in identifying potential biases in the model's outputs. By continuously monitoring and addressing these biases, the platform can improve the fairness and reliability of its AI-generated artifacts. Data lineage refers to the tracking of data as the data moves through different stages of processing, from ingestion to final output. Feedback data 118 can include, for example, records of data transformations, including how the data was pre-processed, curated, and used by the generative AI applications 116. The feedback data 118 provided by generative AI applications 116 can include metadata and audit logs that capture the data lifecycle. LLM tracking includes monitoring the performance and usage of LLMs within the artifact generation platform 104 by tracking model updates, versioning, and performance metrics to ensure that the models are functioning as expected.

The generative AI applications 116 can collect feedback data 118 from users, which the artifact generation platform 104 uses to incrementally train the neural network and improve its performance over time using methods discussed with reference to FIG. 4. User feedback includes explicit feedback, such as user ratings and comments, as well as implicit feedback, such as user interactions and usage patterns. Subject Matter Expert (SME) feedback can further be collected, which can include insights and evaluations from domain experts who review the generated artifacts for accuracy and relevance. The artifact generation platform 104 can use feedback data 118 to incrementally train the neural network in LLM repository 116, improving its performance and accuracy over time. The feedback data 118 ensures that the artifact generation platform 104 can adapt to user preferences and evolving needs, enhancing the quality of the generated outputs. The artifact generation platform 104 can analyze the feedback data using machine learning techniques to identify trends, patterns, and areas for improvement. The feedback data 118 can include user/SME feedback and AI-based feedback and is provided to the LLM repository 114 as a feedback loop with Reinforcement Learning from Human Feedback (RLHF) and/or Reinforcement Learning from AI Feedback (RLAIF). RLHF includes training the model based on feedback from human users, while RLAIF includes training the model based on feedback from other AI systems.

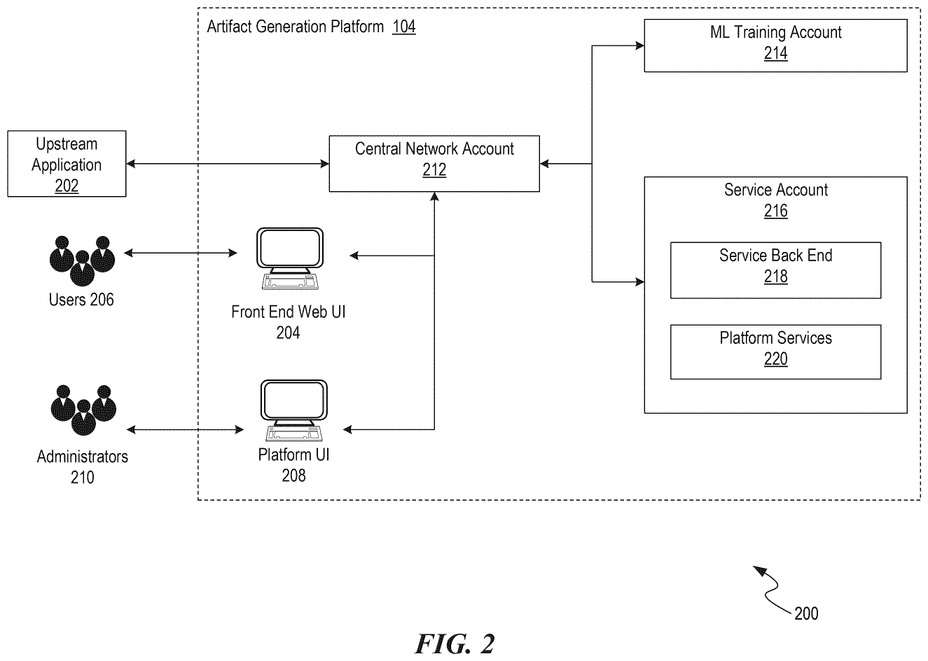

FIG. 2 shows an example architecture 200 of an application supporting the artifact generation platform 104 in accordance with some implementations of the present technology. Example architecture 200 includes client environment 202, front-end web user interface (UI) 204, front-end web users 206, platform UI 208, administrators 210, central network account 212, training account 214, service account 216, service backend 218, and platform services 220. Front-end web UI 204, platform UI 208, central network account 212, training account 214, service account 216, and service backend 218 can be implemented using components of the example computer system 600 illustrated and described in more detail with reference to FIG. 6. Implementations of example architecture 200 can include different and/or additional components that can be connected in different ways.

In an example implementation, upstream applications 202 represent external systems and applications that interact with the artifact generation platform 104. Upstream applications 202 can submit documents for extraction via an ingestion API. For example, a particular upstream application calls the ingestion API to submit source data 102. The URL for the ingestion API can resolve through domain name records to a web application firewall, which filters and monitors HTTP traffic. The firewall can forward the traffic to an application load balancer hosted in a central networking account 212. The request traffic can pass through a firewall before reaching a network load balancer. The ingestion service, which can be hosted in a container service cluster, can process the documents and call various micro-services. The submitted documents can be stored in a data lake, and the ingestion service can call, for example, a pipeline step function workflow to extract information from the documents. In some implementations, the information can be extracted, in whole or in part, using one or more techniques described, for example, in U.S. Pat. No. 11,842,286, incorporated herein by reference.

In some implementations, the front-end web UI 204 serves as the interface through which front-end web users 206 interact with the artifact generation platform 104. In some implementations, a content delivery network (CDN) (e.g., AMAZON CLOUDFRONT) can host the front-end web UI 204 and serves the front-end web UI 204 from edge locations to ensure low latency and high availability. Front-end web users 206 can be the end-users who interact with the artifact generation platform 104 through the front-end web UI 204 to perform tasks such as creating, editing, and managing project artifacts.

Platform administrators 210 can manage and maintain the artifact generation platform 104 by interacting with the platform through the platform UI 208, which is specifically designed for administrative tasks. The tasks can include onboarding new tenants, managing platform configurations, monitoring system performance, and/or ensuring security compliance. For example, administrators 210 can configure user roles, set up security policies, and/or manage resource allocations. The platform UI 208 can be hosted on a CDN to ensure low latency and high availability, similar to the front-end web UI 204. In some implementations, the platform UI 208 connects to an API gateway and is secured by a user authentication service, ensuring that only authorized administrators 210 can access and manage the platform's administrative functions.

The central network account 212 is a dedicated account that hosts networking components such as the application load balancer and firewall. The application load balancer can distribute incoming traffic across multiple targets to ensure high availability and fault tolerance. The firewall can include security features, including threat prevention and traffic monitoring, to protect the platform from malicious activities. On the other hand, the training account 214 is an account for ML model training. Data for model training is stored in a storage service within the training account 214. The data can be pre-processed through a pipeline before being used to train ML models. The trained models can be deployed as endpoints in a separate account, where the artifact generation platform 104 accesses the models for inference tasks. In some implementations, the training account 214 ensures continuous improvement by updating the hyperparameters and/or training data of the models.

Additionally, the service account 216 can be an account that hosts the service backend 218 and related platform services 220. Various microservices can be hosted in a container service cluster to execute tasks such as document ingestion, data extraction, and API management. The service account 216 can store the extracted information in a data lake, where the information can be accessed for further processing and validation. Platform services 220 encompass the various backend services, executables, and tools that support the overall functionality of the artifact generation platform 104. Additionally, platform services 220 can include metrics collection, logging, monitoring, and alerting, to maintain the health and performance of the platform. In some implementations, the platform services 220 include tools for data transformation and enrichment, which improve the quality and usability of the extracted information. For example, a data transformation service can apply various transformations to the extracted data, such as normalization, aggregation, and filtering, to pre-process the data for downstream operations. A data enrichment service can augment the extracted data with additional context and metadata, such as linking extracted entities to external knowledge bases or adding geolocation information based on extracted addresses to generate more insightful project artifacts.

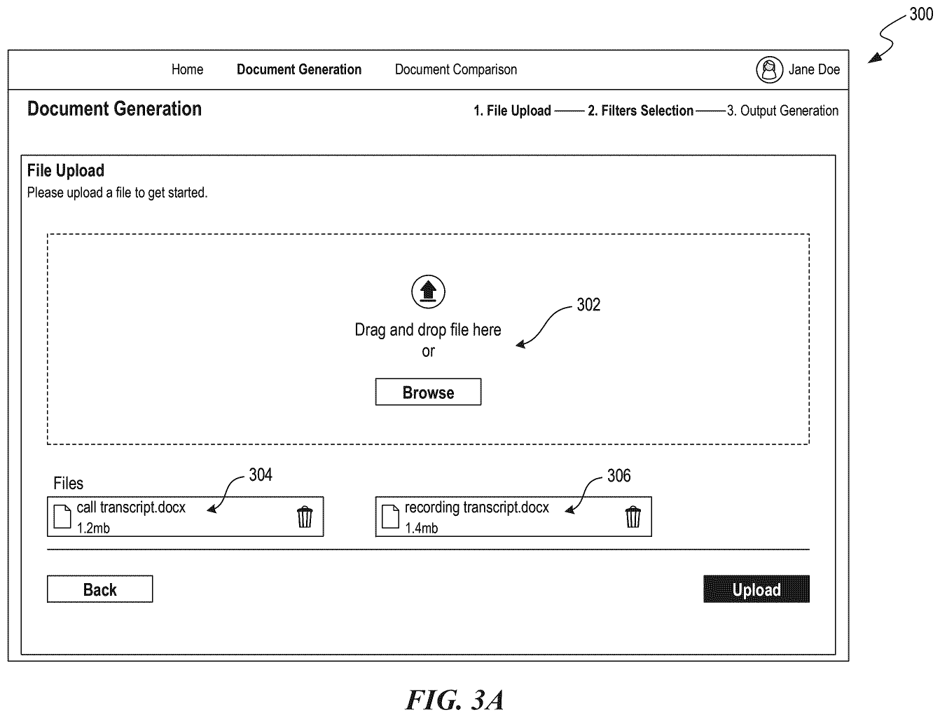

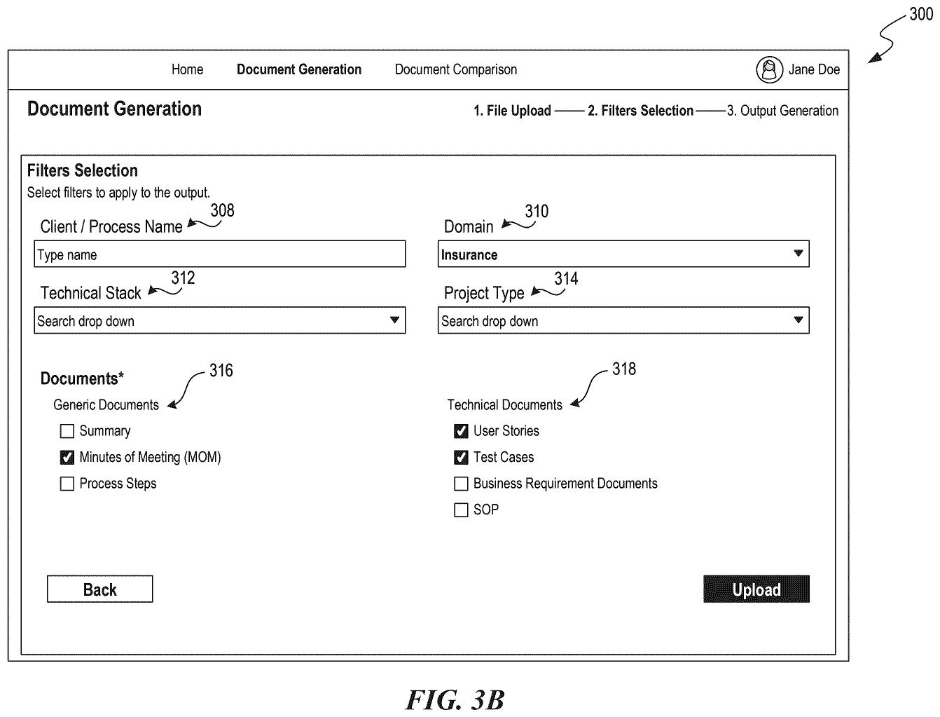

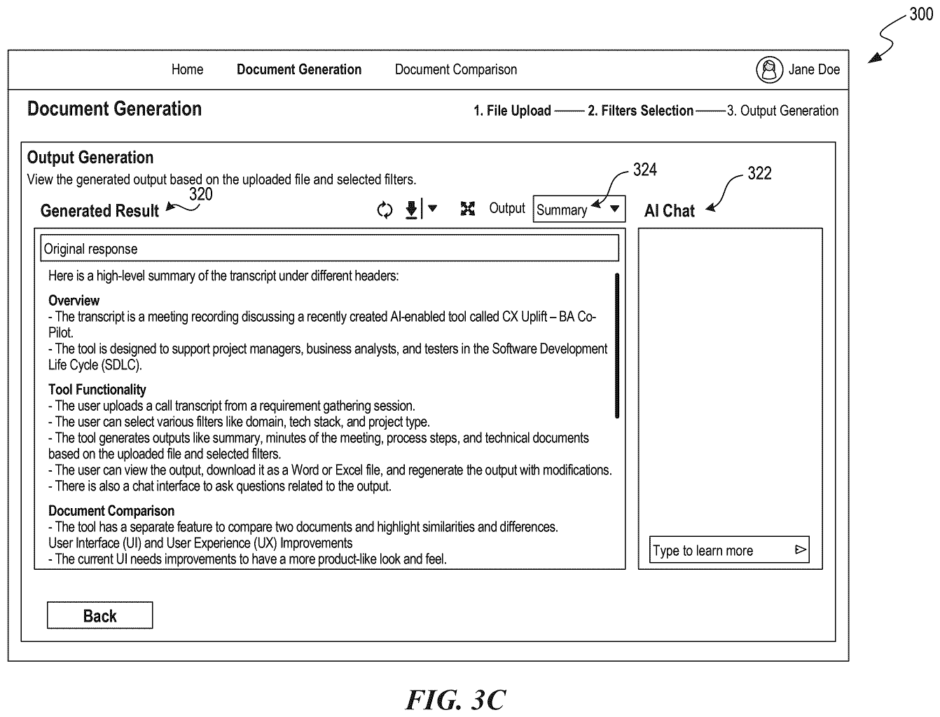

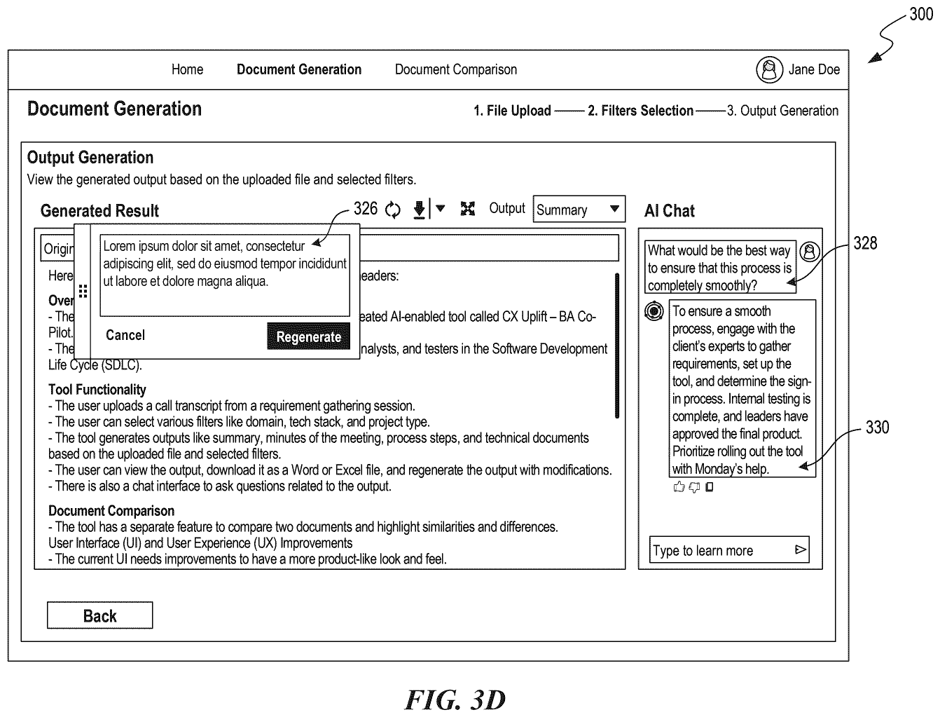

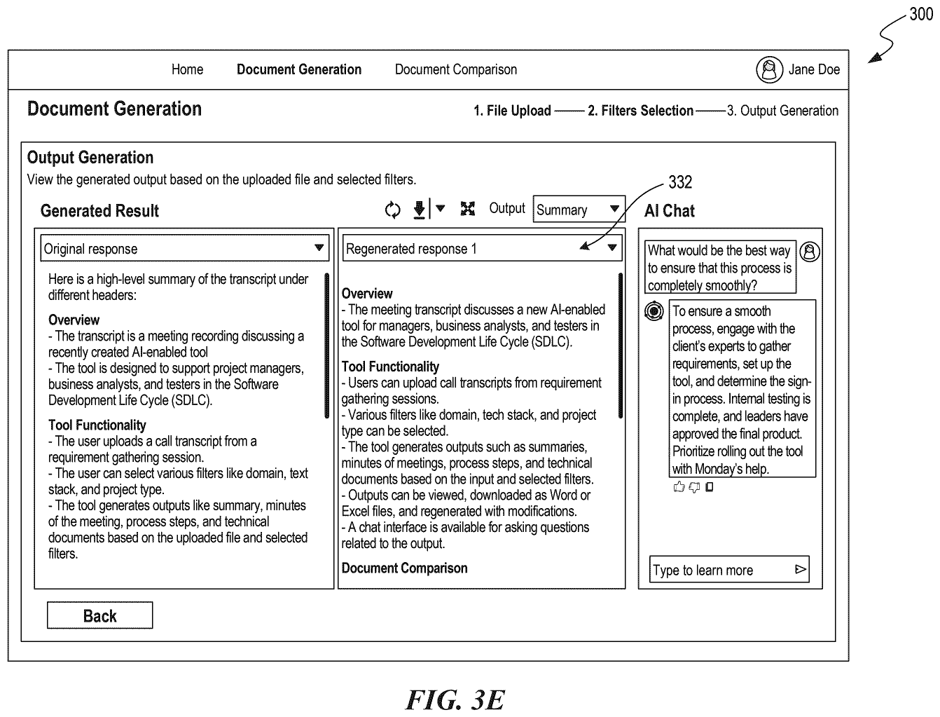

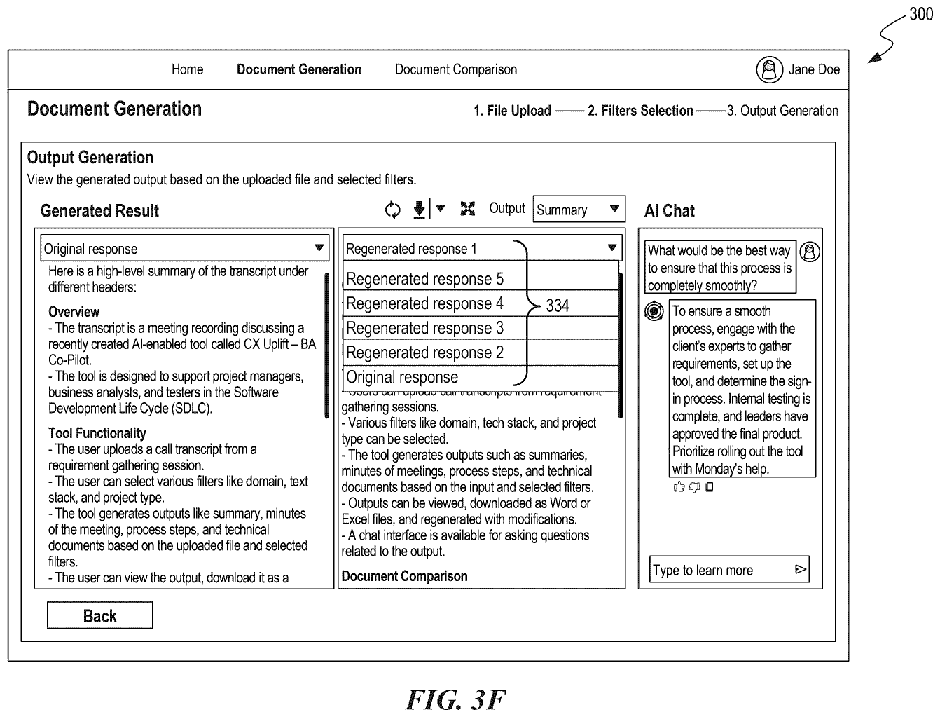

FIG. 3A shows an example GUI 300 that demonstrates aspects of an instruction interface of the artifact generation platform 104 in accordance with some implementations of the present technology. In FIG. 3A, GUI 300 includes upload indicator 302 and files (e.g., a first file 304, a second file 306). GUI 300 is implemented using components of the example computer system 600 illustrated and described in more detail with reference to FIG. 6. Implementations of GUI 300 can include different and/or additional components or can be connected in different ways.

The upload indicator 302 can be a visual cue to inform users about the status of their file uploads. For example, the upload indicator 302 can include a “drag and drop file here” area and a “browse” button to enable users to either drag and drop their files (e.g., files 304, 306) directly into the designated area or click the browse button to select files from their file system. When a user drags a file into the designated area, the upload indicator 302 can highlight the area to confirm the action. Once the upload completes, the upload indicator 302 can change to indicate that the file has been successfully uploaded and is ready for processing.

The files (e.g., a first file 304, a second file 306) represent the files that users have uploaded to the platform. Files 304 can represent the initial set of documents from which operative standards are extracted, and the documents can come in multiple formats, such as PDF, Word, plain text, HTML, or multimedia formats such as images, audiovisual, or audio files. Different sources, including document management systems, cloud storage services, email attachments, or local file systems, can provide these documents. Each file can display as a distinct item within the GUI 300, with relevant metadata such as file name, upload date, and/or file size. For example, file 304 can be a telephone call transcript of a project meeting, while file 306 can be an audio recording of a conference call. In some implementations, the GUI 300 can include additional features such as a search bar that enables users to locate specific files based on keywords or metadata. The GUI 300 can also include filtering options that enable users to sort and filter the displayed files based on criteria such as file type, upload date, or file size.

FIG. 3B shows an example GUI 300 that demonstrates aspects of a filter interface of the artifact generation platform 104 in accordance with some implementations of the present technology. In FIG. 3B, GUI 300 includes user filter 308, domain filter 310, technical stack filter 312, project type filter 314, generic document filter 316, and technical document filter 318. The user filter 308 enables users to filter data based on specific user attributes. For example, a project manager seeks to view documents created by a particular team member. The user filter 308 can provide options to select users from a list, enabling the display of documents associated with the selected users. The user filter 308 helps in narrowing down the data to user-specific contributions to facilitate the tracking of individual performance and contributions. Additionally, the domain filter 310 enables users to filter generate project artifacts based on specific domains. The domain filter 310 provides options to select from various domains such as software development, healthcare, finance, education, insurance, and so forth. For example, a software developer seeks to view artifacts specific to the software development lifecycle such as, for example, requirements specifications, design documents, code repositories, test plans, and/or deployment scripts.

The technical stack filter 312 enables users to filter data based on the technical stack used in a project. For example, a software developer seeks to view documents related to projects that use a specific programming language or framework, such as PYTHON or REACT. The technical stack filter 312 provides options to select from various technical stacks, enabling the display of documents associated with the selected technologies. The project type filter 314 enables users to filter data based on the type of project. For example, a user seeks to view documents related to agile projects, waterfall projects, or research projects.

Document filters such as the generic document filter 316 enables users to filter data based on generic document types. For example, in FIG. 3B, a user seeks to view documents such as summaries, but not of minutes of meetings (MoMs) or process steps. Similarly, the technical document filter 318 enables users to filter data based on technical document types. For example, in FIG. 3B, a user seeks to view documents such as user stories and test cases, but not business requirement documents or standard operating procedures (SOP). By applying the filters, users can quickly access the documents and artifacts needed while excluding other types of documents and artifacts that are not relevant to their current task.

FIG. 3C shows an example GUI 300 that demonstrates aspects of an output display interface of the artifact generation platform 104 in accordance with some implementations of the present technology. In FIG. 3C, GUI 300 includes generated artifact 320, chat bot interface 322, and artifact type indicator 324. The generated artifact 320 is the primary area where the output of the artifact generation process is displayed. The generated artifact 320 section presents the generated project artifacts, such as documents, summaries, or reports, in a clear and organized format. The generated artifact 320 is dynamically populated with content generated by the artifact generation platform 104. The generated artifact 320 can take the form of various multi-modal content types, such as text, images, audio, tables, and/or charts.

In some implementations, the artifact generation platform 104 is integrated with a chat bot. The chat bot interface 322 is an interactive feature that enables users to engage with the artifact generation platform 104 through natural language queries. The chat bot interface 322 provides a conversational method for users to request specific information, ask questions about the generated artifacts, and/or seek further clarifications. The chat bot interface 322 is integrated with the artifact generation platform 104 using methods discussed with reference to FIG. 4. The chat bot interface 322 can process various queries, from simple requests for specific documents to complex questions about the content of the generated artifacts. The chat bot interface 322 can support multi-turn conversations, enabling users to engage in a back-and-forth dialogue with the chat bot to refine their queries and obtain more precise information.

The artifact type indicator 324 is a visual element that displays the type of output generated by the artifact generation platform. The artifact type indicator 324 enables users to quickly identify the nature of the generated content, such as whether it is a summary, a detailed report, a user story, or any other type of project artifact. The artifact type indicator 324 can be implemented as a dynamic label or icon that updates based on the type of content generated. The artifact generation platform 104 can, for example, tag each generated artifact with metadata that includes the output type. The artifact type indicator 324 reads the metadata and displays the corresponding label or icon in the GUI.

FIG. 3D shows an example GUI 300 that demonstrates aspects of a chat bot interface of the artifact generation platform 104 in accordance with some implementations of the present technology. In FIG. 3D, GUI 300 includes update 326, query 328, and response 330. The update 326 enables users to request an updated or revised version of the previously generated artifact 320. For instance, if the generated artifact 320 does not fully meet the user's requirements or if additional information has become available, the user can trigger the update 326 component to regenerate the artifact 320. The update 326 component triggers the artifact generation platform 104 to re-evaluate the input data, apply the trained neural network(s), and generate a revised artifact that reflects the latest information and user feedback.

The query 328 in the chat bot interface 322 is the input area where users can enter their natural language queries. The query 328 component supports various types of queries, including requests for specific documents, questions about the content of generated artifacts, and commands to perform specific actions within the platform. The response 330 in the chat bot interface 322 component is the output area where the artifact generation platform 104 displays the responses to user queries. The response 330 can be various types of content, including text, images, tables, and charts, depending on the nature of the query and the generated artifacts and/or the query 328.

FIG. 3E shows an example GUI 300 that demonstrates aspects of a regeneration interface of the artifact generation platform 104 in accordance with some implementations of the present technology. In FIG. 3E, GUI 300 includes regenerated artifact 332. The regenerated artifact 332 is an updated version of the generated artifact 320 in accordance with update 326. Methods of regenerating the generated artifact 320 are discussed with further detail in FIG. 4.

FIG. 3F shows an example GUI 300 that demonstrates aspects of an artifact management interface of the artifact generation platform 104 in accordance with some implementations of the present technology. In FIG. 3F, GUI 300 includes response generation history 334. The response generation history 334 provides a chronological log of all generated responses. The log can include details such as the timestamp of each response, the type of artifact generated, the user who initiated the request, and/or any relevant metadata. The response generation history 334 ensures that users can easily review and interact with the historical data, and enables users to track the evolution of the project artifacts over time. In some implementations, project artifacts can be compared using methods discussed with reference to FIG. 4. The response generation history 334 is implemented using a database that stores all generated responses along with their associated metadata. When a new response is generated, the artifact generation platform 104 automatically logs the details in the response generation history 334. Metadata included in the response generation history 334 can include, for example, a timestamp indicating when the response was generated, the type of artifact generated (such as a project summary, meeting minutes, or user story), details about the user who initiated the request, the input data used for generation, any specific instructions provided by the user, and/or the version of the neural network model applied.

### Example Methods of Operation of the Artifact Generation Platform

FIG. 4 is a flowchart depicting an example method 400 of operation of the artifact generation platform 104 of FIG. 1, in accordance with some implementations of the present technology. In some implementations, the method 400 is performed by components of the example computer system 600 illustrated and described in more detail with reference to FIG. 6. Likewise, implementations can include different and/or additional operations or can perform the operations in different orders.

In operation 402, the artifact generation platform 104 generates a set of tokens for a project artifact using a set of files (e.g., video, audio, audiovisual, textual files). For example, the artifact generation platform 104 reads the video file and extracts frames at specific intervals. In some implementations, the frames are resized to a standard resolution, converted to grayscale to reduce computational complexity, and/or adjusted with filters to enhance edges and key features. The frames can be evaluated using deep learning models such as YOLO (You Only Look Once) or Faster R-CNN (Region-based Convolutional Neural Networks), identify and classify objects, text, and other relevant elements within each frame. The detected objects and their attributes (e.g., position, size, and label) can be recorded. In some implementations, the artifact generation platform 104 applies Optical Character Recognition (OCR) to extract text from the frames.

The information extracted from the frames, including detected objects and recognized text, is converted into tokens. For example, a token could represent a specific object (e.g., “laptop”), a piece of text (e.g., “Project Deadline: June 30”), or an action (e.g., “person speaking”). The artifact generation platform 104 can use NLP to generate tokens that capture the semantic meaning and context of the extracted information. To ensure that the tokens accurately represent the content and context of the video, the artifact generation platform 104 can use sequence modeling (e.g., using LSTM or Transformer models) and semantic analysis to capture the temporal and contextual dependencies between tokens. The generated tokens can be stored in a structured format, such as a database or a token repository. The artifact generation platform 104 can maintain metadata for each token, including its source frame, timestamp, and any associated attributes.

In some implementations, the artifact generation platform 104 detects a start frame and an end frame in the set of video frames. Using a subset of frames between and including the start frame and the end frame, the artifact generation platform 104 can generate a transcript token and a context token. To detect the start and end frame, the artifact generation platform 104 can identify key markers or events that signify the beginning and end of a relevant segment. For example, scene changes, audio cues, or predefined timestamps can be used to accurately pinpoint these frames. Scene changes can be detected using computer vision algorithms that analyze frame-by-frame differences in visual content to detect objects, track movements, and recognize patterns.

For files including an image component, the artifact generation platform 104 can compare the color histograms of consecutive frames, where a significant difference can indicate a scene change. For example, if a first frame has a color histogram value of 0.2 and a second frame has a value of 0.98, the difference of 0.78 exceeds a threshold of, for example, 0.75, thus indicating a scene change. Further, the artifact generation platform 104 can identify the boundaries within an image by detecting discontinuities in brightness, helping to recognize distinct objects and changes in the scene. For example, if a first frame has an average brightness of 100 and a second frame has an average brightness of 160, the difference of 60 exceeds a threshold of, for example, 50, thus indicating a scene change. Additionally, the artifact generation platform 104 can track the movement of objects within a sequence of frames, where changes in motion patterns (e.g., pixels per second) beyond a certain threshold can indicate scene transitions. For example, if an object moves at a speed of 10 pixels/second in a first frame and changes to 35 pixels/second in a second frame, the difference of 25 pixels/second exceeds a threshold of, for example, 20 pixels/second, thus indicating a scene transition.

For files including an audio component, the artifact generation platform 104 can analyze the audio track for specific patterns, such as changes in volume, pitch, or the presence of particular sounds or speech. For instance, the artifact generation platform 104 can use voice activity detection (VAD) to identify segments where speech occurs. VAD detects the presence of human speech within an audio signal by distinguishing speech from non-speech segments by identifying patterns that are characteristic of human speech, such as consistent energy levels and specific frequency ranges. Spectral analysis, which analyzes the frequency spectrum of an audio signal, helps in identifying specific audio events such as claps, beeps, or music transitions by examining the distribution of frequencies. In some implementations, the artifact generation platform 104 can use metadata embedded within the media files, such as timecodes or markers, to accurately locate the beginning and end of segments. Metadata can include information such as timecodes, markers, and descriptions that help in organizing and locating content.

Additionally, the artifact generation platform 104 can use machine learning models trained on annotated datasets to improve the accuracy of start and end frame detection. The machine learning models can be trained to recognize patterns that indicate the start and end of segments. The annotated datasets can be labeled with segmentation information, such as the start and end points of known segments.

Once the start and end frames are identified, the platform extracts a subset of frames between and including these markers. Using the subset, the platform generates a transcript token and a context token. The transcript token is a textual representation of the spoken content within the selected frames. The transcript token can be created by applying speech-to-text algorithms to the audio track associated with the selected frames. The platform can generate a context token by analyzing the visual and contextual elements within the subset of frames to capture the objects, actions, scenes, and their relationships. Object detection and recognition algorithms discussed above can be used to identify key objects, actions, and scenes. Techniques such as named entity recognition (NER), part-of-speech tagging, and dependency parsing can be used to identify and categorize entities, determine the grammatical structure of sentences, and understand the relationships between words and phrases. For example, NER can identify entities such as people, organizations, and locations within the transcript, while dependency parsing can reveal the syntactic structure of sentences and the relationships between different elements.

In operation 404, using a graphical user interface (GUI), the artifact generation platform 104 captures an output type instruction. The output type instruction can be indicative of specific output type, such as a call summary, meeting minutes, a user story, a test case, a business requirements document, and/or process steps. Each output type is associated with a specific format and structure, to meet different requirements of different project documentation needs.

Once the user selects an output type instruction, the artifact generation platform 104 uses the output type instruction to determine the structure, content, and format of the generated artifact. For example, if the user selects “call summary,” the platform focuses on extracting key points, action items, and decisions from the transcript tokens and context tokens. If “meeting minutes” is chosen, the platform organizes the information into a detailed record of the meeting, including attendees, agenda items, discussions, and outcomes. Similarly, selecting “user story” prompts the platform to generate a narrative that captures user requirements and acceptance criteria, while “test case” results in a structured document outlining test scenarios, steps, and expected outcomes.

In operation 406, using the output type instruction and the set of tokens, the artifact generation platform 104 can cause a trained neural network to generate the project artifact according to a specific output type. The artifact generation platform 104 feeds the set of tokens, which include transcript tokens and/or context tokens, into the neural network along with the specific output type instruction. The neural network uses its training to interpret the tokens, extracting relevant information and organizing it according to the structure and format dictated by the output type instruction. In some implementations, the project artifact is a body of text.

The neural network can be trained on a diverse dataset of project documents, including call summaries, meeting minutes, user stories, test cases, BRDs, and process steps. The training dataset can include documents annotated with project artifact features such as project type, user role, domain, and technology stack descriptors. During training, the neural network learns to recognize patterns, structures, and key elements within the artifacts, enabling it to generate coherent and contextually accurate artifacts.

The generated project artifact can include a body of text, and be generated in accordance with a project type, a user role, a domain, and/or a technology stack descriptor. The body of text is the main content of the artifact, which the neural network constructs by synthesizing the information from the tokens. For instance, if the output type instruction specifies a “business requirements document,” the neural network generates a detailed text outlining the project's objectives, requirements, and constraints. The project type component categorizes the artifact within a specific project domain, such as insurance, software development, marketing, or regulatory compliance, ensuring that the content is relevant to the project's context. The user role component can adjust the artifact to fit the needs and perspectives of different stakeholders, such as project managers, developers, or business analysts, by emphasizing information pertinent to their roles.

In some implementations, the context token includes a relevance score that corresponds to the transcript token. The relevance score can be indicative of a relevance level of the transcript token with the specific output type, the project type, the user role, the domain, and/or the technology stack descriptor. For instance, if the specific output type is a project summary, the model can evaluate how well the transcript token aligns with the typical content and structure of a project summary. Similarly, for the project type, the model assesses whether the transcript token contains information that is critical for that particular type of project, such as milestones for a software development project or compliance requirements for a regulatory project.

To calculate the relevance score, the artifact generation platform 104 can define the criteria for relevance based on the specific output type instruction obtained in operation 404. For example, for a project summary, the criteria can include alignment with typical content and structure, such as milestones, objectives, and outcomes. For different project types, the criteria can include specific information relevant to that type, such as milestones for software development projects or compliance requirements for regulatory projects. To determine the alignment of the tokens with the criteria, the artifact generation platform 104 can convert the tokens into vector representations using techniques such as word embeddings (e.g., Word2Vec, GloVe) or contextual embeddings (e.g., BERT, GPT) to transform the textual content of the tokens into high-dimensional vectors that capture semantic meaning and contextual relationships. The vector representations enable for the application of mathematical operations to measure similarity and relevance. For instance, cosine similarity can be used to compare the vectors to provide a quantitative measure of how closely the transcript token aligns with the context token based on the defined criteria.

In some implementations, the relevance score is associated at least in part based on frame metadata. The frame metadata can correspond to the set of video frames and/or transcript token metadata. Once the speakers are identified, the platform can cross-reference the transcript token with metadata to determine the user role of each speaker. Metadata can include information such as speaker labels, timestamps, and contextual cues from the video. For instance, if the video is a recorded meeting, the metadata can contain participant names, roles, and speaking times, which can be extracted from meeting invitations, attendance records, or manual annotations.

Similarly to the process of assigning a relevance score to the transcript token, the artifact generation platform 104 can assign a relevance score to the context token. This score quantifies the degree of contextual similarity, providing a metric that can be used to prioritize and filter tokens during the artifact generation process. The relevance score can be calculated at least in part based on the user role. The artifact generation platform 104 can determine the user role in connection with identifying a speaker using the transcript token or metadata associated with the transcript token. The artifact generation platform 104 can use one or more ML models to recognize and distinguish between different voices based on acoustic features.

In some implementations, by examining the language, terminology, and topics discussed by each speaker, the artifact generation platform 104 can infer their roles. For example, a speaker frequently discussing project timelines, resource allocation, and deliverables is likely to be a project manager, while another speaker focusing on technical specifications, code reviews, and software bugs is likely to be a developer. The platform can use predefined role profiles that contain typical language patterns and topics associated with various user roles to enhance this inference process. In some implementations, the artifact generation platform 104 can integrate with structured databases and user profiles to obtain more accurate role information. By accessing user directories, employee records, and project management tools, the artifact generation platform 104 can match speakers to their respective roles within the organization. This integration enables the artifact generation platform 104 to validate its inferences and ensure that the identified roles are accurate and up-to-date.

In some implementations, the artifact generation platform 104 can generate a sensitivity indicator using the transcript token or metadata associated with the transcript token. The sensitivity indicator can quantify the level of confidentiality and sensitivity of the information. For example, the sensitivity indicator can be a particular value on a predefined scale (e.g., scale from 0 to 100, 0 to 1). If the sensitivity indicator exceeds a predetermined threshold (e.g., 70, 0.7), the platform omits the transcript token from the context for the chat bot to prevent the disclosure of sensitive information. The sensitivity indicator ensures that sensitive data is protected, maintaining confidentiality and compliance with data protection regulations. Additional measures such as including anonymization to obfuscate sensitive data, access controls to restrict data access, and logging to provide an audit trail can be used to further enhance data protection.

To determine the sensitivity indicator, the artifact generation platform 104 can define sensitivity criteria based on keywords, phrases, and/or regulatory requirements, and parse through the transcript token and/or context token to identify sensitive information such as personal identifiers and financial data. In some implementations, the artifact generation platform 104 can include trained machine learning models trained on annotated datasets containing examples of sensitive and non-sensitive information. The artifact generation platform 104 then generates a sensitivity score for each transcript token using the trained model. If this score exceeds a predetermined threshold (e.g., 70 out of 100, 0.7 out of 1), the artifact generation platform 104 omits the transcript token from the context for the chat bot to prevent the disclosure of sensitive information.

In operation 408, the artifact generation platform 104 can cause the GUI to generate and/or display a first component comprising the project artifact and a second component comprising a chat bot. The context for the chat bot can be set to the project artifact. The first component, the project artifact, is the output generated by the trained neural network based on the user's specific output type instruction and the set of tokens. The project artifact is presented in a well-organized and readable format, tailored to the specific needs of the user. The second component, the chat bot, is designed to facilitate interactive user engagement with the project artifact. The chat bot is contextually aware, meaning its responses and interactions are informed by the content of the project artifact. This is achieved by setting the context for the chat bot to the project artifact, enabling it to access and reference the information contained within the document. The artifact generation platform 104 can set the context for the chatbot by, for example, using configuration files, where the generated project artifact is stored in a particular set of configuration files that the chatbot reads during execution of the chatbot's initialization scripts or functions. The configuration can include details such as user roles, project names, and other relevant information. In some implementations, the chatbot can be pre-loaded with query context to query a particular database including, for example, the most recently generated project artifact. The dynamic context updating ensures that the chatbot remains accurate and relevant throughout the interaction, even as project artifact details change over time.

In operation 410, responsive to detecting a user query, the artifact generation platform 104 can cause the chat bot to search the project artifact displayed in the first component. Users can interact with the chat bot by asking questions, seeking clarifications, or requesting additional details about specific sections of the artifact. The chat bot uses NLP capabilities to understand user queries and provide accurate and relevant responses.

When a user inputs a query, the chat bot first can split the query into individual words or tokens, and tag the particular words and tokens with its corresponding part of speech, such as noun, verb, adjective, etc. NER can be applied to identify and classify key entities within the query, such as names of people, organizations, dates, and technical terms. For example, if the query is “What are the milestones for the software development project?”, the chat bot can identify “milestones” as the key entity and “software development project” as the context.

The chat bot can use its knowledge base, which includes the project artifact, to generate a response. in some implementations, the chat bot matches the query context with the project artifact by creating a vector representation of the query and tokenized sections of the project artifact (e.g., predefined length, or dynamically sized using methods discussed with reference to operation 402). The chat bot can perform a similarity search using methods such as cosine similarity or nearest neighbor search to find sections of the artifact that closely match the query context. The chat bot can use one or more machine learning models trained on large datasets of conversational data to predict the most appropriate and contextually relevant response. The chat bot can reference specific sections of the project artifact, extract pertinent information, and present the information to the user. In some implementations, the chat bot can summarize portions of the project artifact. For example, if the section contains a list of project milestones, the chat bot can extract and format the milestones to present them in a concise manner.

In some implementations, the generated project artifact is a first observed project artifact. The artifact generation platform 104 can receive a set of user input comprising attributes of an expected project artifact of the output type instruction (e.g., feedback data 118 in FIG. 1). Users can provide feedback on various attributes of the first observed project artifact, such as its relevance to the project context, the accuracy of the information presented, and the completeness of the content. The artifact generation platform 104 can incrementally adjust parameters of the trained neural network using the set of user input. The trained neural network can use the adjusted parameters to generate a second observed project artifact including the attributes of the expected project artifact.

Adjusting the neural network's parameters can include using techniques such as stochastic gradient descent (SGD) or the Adam optimizer to fine-tune the network's weights and biases based on the expected attributes. To measure the performance of the adjustment, the artifact generation platform 104 can calculate the difference between the network's generated artifacts and the expected artifacts by converting the artifacts into numerical vectors, matrices, or other structured representations. For example, if the artifacts are text documents, the artifacts can be represented as sequences of word embeddings or other numerical encodings. The artifact generation platform 104 can use a loss function to measure the difference between the representations. For instance, if the artifacts are represented as vectors, the loss function can calculate the Euclidean distance or cosine similarity between the vectors. If the artifacts are sequences, the loss function can use a sequence-based metric such as the Levenshtein distance to measure the number of edits needed to transform one sequence into the other. Once the differences are computed, the loss function can aggregate the differences into a single error value. The aggregation can involve summing the individual differences, averaging them, or weighing certain types of differences more heavily. The resulting error value provides a quantitative measure of how closely the generated artifact matches the expected artifact.

In some implementations, the artifact generation platform 104 can generate a first set of operative standards within a first set of files. Each operative standard in the first set of operative standards satisfies constraints of the first set of files. Operative standards refer to a predefined protocol, clause, obligation, action, or lack of action that is expected to be followed within a given context (e.g., compliance with regulatory requirements, company policies, industry best practices, guidelines). The artifact generation platform 104 can provide a second set of operative standards of a second set of files, and identify a set of gaps by comparing the first set of operative standards with the second set of operative standards. The second set of files can represent a different time period, team, or set of conditions. The set of gaps include actions present in the second set of operative standards and absent in the first set of operative standards.

For example, the first set of files can be a first set of contracts. To extract the operative standards from the first set of text files, the artifact generation platform 104 can use NER to identify parties involved, dates, and monetary amounts, and isolate specific sections such as payment terms, confidentiality agreements, liability limitations, and termination conditions. An ML model can be trained on a labeled dataset of contracts to recognize entities such as parties involved (e.g., “Company A,” “Vendor B”), dates (e.g., “Jan. 1, 2026”), and monetary amounts (e.g., “$10,000”). To isolate specific sections of the contracts, the artifact generation platform 104 can segment the contract text into clauses and classify the clauses into predefined categories such as payment terms, confidentiality agreements, liability limitations, and termination conditions. The artifact generation platform 104 can use a one of or a combination of rule-based methods and machine learning classifiers. For instance, regular expressions can be used to identify common patterns in clause headings, while a supervised learning model can classify the extracted clauses based on their content. In some implementations, the artifact generation platform 104 can use semantic analysis techniques to understand the meaning and context of the extracted clauses using vector space models, such as Word2Vec or GloVe, to represent words and phrases as vectors in a high-dimensional space. By comparing the vectors of the first set of files, the artifact generation platform 104 can determine the semantic similarity between different clauses and identify variations in wording that may still convey the same meaning (e.g., to detect subtle differences in contract language that could impact the interpretation of the terms).

Once the operative standards are extracted, the operative standards can be compared across documents (e.g., a second set of files or contracts). For example, a user can use the comparison to ensure that the first and second set of contracts include a confidentiality clause with specific language. The artifact generation platform 104 can identify equivalent operative standards in the first and second sets of contracts using, for example, rule-based methods to match clauses based on specific keywords or phrases. For example, the artifact generation platform 104 can match confidentiality clauses by identifying common terms such as “confidential information,” “non-disclosure,” and “proprietary information.” The set of gaps includes clauses or terms present in the second set of operative standards but absent in the first set. For example, if the second set of contracts includes a new indemnity clause that is not present in the first set, this clause is flagged as a gap.

The artifact generation platform 104 can quantify the significance of each gap based on factors such as frequency, impact, and compliance risk. Frequency analysis determines how often a particular gap occurs across the documents. Impact assessment evaluates the potential consequences of the gap on the contract's enforceability, compliance, and risk exposure. Compliance risk analysis assesses the likelihood of regulatory or legal issues arising from the gap. For example, a missing indemnity clause can be flagged as high-risk due to its potential impact on liability and legal protection.

In some implementations, the artifact generation platform 104 can trigger automated alerts to notify users of gaps that cross a predetermined threshold or satisfy predetermined criteria (e.g., high risk). The artifact generation platform 104 can, in some implementations, initiate and/or complete computer-executable workflows to review and amend the files (e.g., by adding a missing contract clause, adding a contract clause), ensuring that the necessary changes are made to align with the operative standards. For example, the artifact generation platform 104 can create tasks or assignments for the relevant team members to address the identified gaps. Workflow management tools or project management software can be integrated with the artifact generation platform 104. For example, a task can be created in a project management tool, assigning a legal team member to add the missing contract clause. The artifact generation platform 104 can use to communicate with these tools. The artifact generation platform 104 can automatically generate a task with information about the identified gap (e.g., a description of the gap, the location in the artifact, the potential impact, recommended actions). The task can be assigned to the relevant team member or group based on predefined roles and responsibilities. For instance, if a missing contract clause is detected, the task can be assigned to a legal team member.

### Example Implementation of the Neural Network(s) of the Artifact Generation Platform

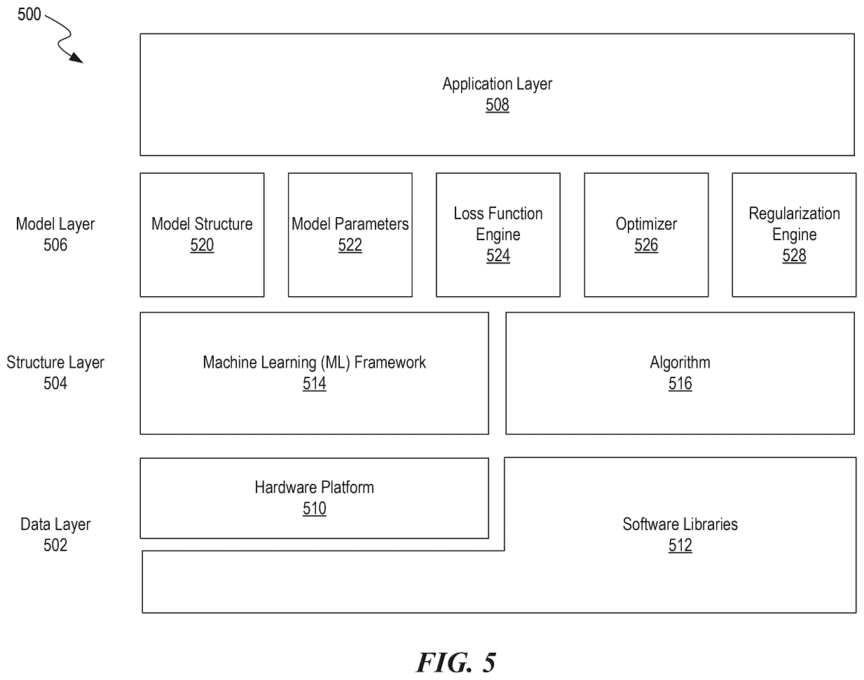

FIG. 5 illustrates a layered architecture of an artificial intelligence (AI) system 500 that can implement the ML models of the artifact generation platform 104 of FIG. 1, in accordance with some implementations of the present technology. Example ML models can include the models executed by the artifact generation platform 104, such as model repository 114. Accordingly, the model repository 114 can include one or more components of the AI system 500.

As shown, the AI system 500 can include a set of layers, which conceptually organize elements within an example network topology for the AI system's architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

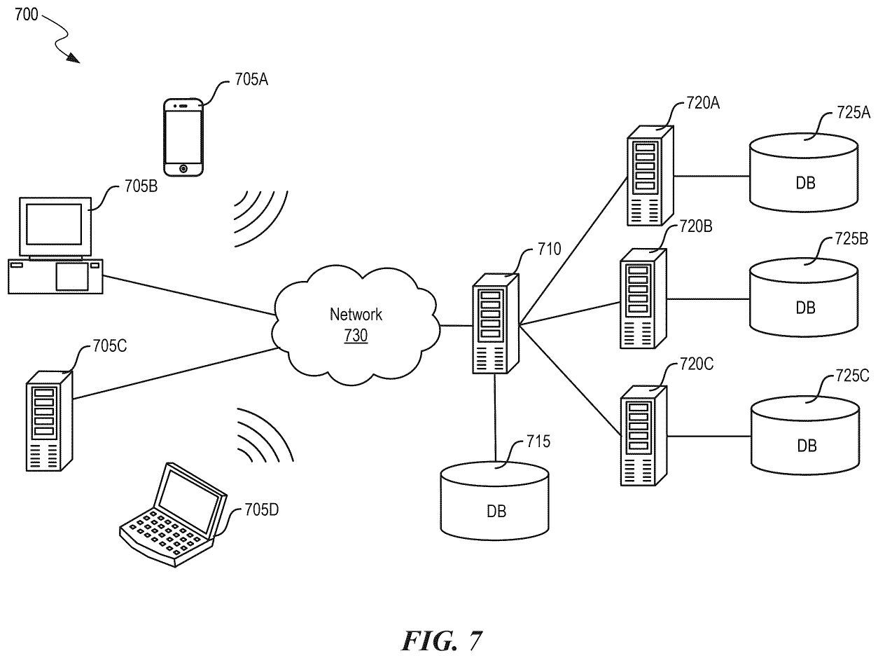

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking, such as the resources described in relation to FIGS. 6 and 7. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, enabling them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that enables users to build and deploy the AI model. The ML framework 514 can include an open-source library, an API, a gradient-boosting library, an ensemble method, and/or a deep learning toolkit that work with the layers of the AI system facilitate development of the AI model. For example, the ML framework 514 can distribute processes for application or training of the AI model across multiple resources in the hardware platform 510. The ML framework 514 can also include a set of pre-built components that have the functionality to implement and train the AI model and enable users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include TENSORFLOW, PYTORCH, SCIKIT-LEARN, KERAS, LightGBM, RANDOM FOREST, and AMAZON WEB SERVICES.

The algorithm 516 can be an organized set of computer-executable operations used to generate output data from a set of input data and can be described using pseudocode. The algorithm 516 can include complex code that enables the computing resources to learn from new input data and create new/modified outputs based on what was learned. In some implementations, the algorithm 516 can build the AI model through being trained while running computing resources of the hardware platform 510. This training enables the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning.

Using supervised learning, the algorithm 516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of source data 102 in FIG. 1) from various source computing systems described in relation to FIG. 1. Furthermore, training data can include pre-processed data generated by various engines of the artifact generation platform 104 described in relation to FIG. 1. The user may label the training data based on one or more classes and trains the AI model by inputting the training data to the algorithm 516. The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format. The artifact generation platform 104 can use unsupervised learning to identify patterns in claim history (e.g., to identify particular event sequences) and so forth. In some implementations, performance of the model repository 114 that can use unsupervised learning is improved because the incoming source data 102 is pre-processed and reduced, based on the relevant triggers, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model using data from the data layer and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model's performance during training. For instance, the loss function engine 524 can measure the difference between a predicted output of the AI model and the actual output of the AI model and is used to guide optimization of the AI model during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over- and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the front-end web UI 304 of the artifact generation platform 104.

### Example Computing Environment of the Artifact Generation Platform

FIG. 6 is a block diagram showing some of the components typically incorporated in at least some of the computer systems and other devices 600 on which the disclosed system operates in accordance with some implementations of the present technology. As shown, an example computer system 600 can include: one or more processors 602, main memory 608, non-volatile memory 612, a network interface device 614, video display device 620, an input/output device 622, a control device 624 (e.g., keyboard and pointing device), a drive unit 626 that includes a machine-readable medium 628, and a signal generation device 632 that are communicatively connected to a bus 618. The bus 618 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementations, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 614 enables the computer system 600 to exchange data in a network 616 with an entity that is external to the computing system 600 through any communication protocol supported by the computer system 600 and the external entity. Examples of the network interface device 614 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 608, non-volatile memory 612, machine-readable medium 628) can be local, remote, or distributed. Although shown as a single medium, the machine-readable medium 628 can include multiple media (e.g., a centralized/distributed database and/or associated caches and servers) that store one or more sets of instructions 630. The machine-readable (storage) medium 628 can include any medium that is capable of storing, encoding, or carrying a set of instructions for execution by the computer system 600. The machine-readable medium 628 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 610, 630) set at various times in various memory and storage devices in computing device(s). When read and executed by the processor 602, the instruction(s) cause the computer system 600 to perform operations to execute elements involving the various aspects of the disclosure.

FIG. 7 is a system diagram illustrating an example of a computing environment in which the disclosed system operates in some implementations. In some implementations, environment 700 includes one or more client computing devices 705A-D, examples of which can host the artifact generation platform 104 of FIG. 1. Client computing devices 705 operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server computing devices 710 and 720 comprise computing systems, such as the artifact generation platform 104 of FIG. 1. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as claims data, email data, call transcripts, call logs, policy data and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### Example Use Cases of the Artifact Generation Platform

Various use cases for the artifact generation platform, such as artifact generation in a business analyst co-pilot mode during the requirement gathering phase, are described above. For instance, when creating BRDs and user story documents, business analysts may engage in extended discussions with business teams and stakeholders to understand the problem statement and devise business solutions. The artifact generation platform can automatically transcribe the discussions, extract relevant information, and generate comprehensive BRDs and user story documents (i.e., project artifacts). Further, the artifact generation platform can generate project artifacts based on the domain of the user, ensuring that the artifacts are tailored to meet the unique requirements of various industries such as insurance, telecommunications, utilities, professional services, healthcare, and/or retail. Similarly, the artifact generation platform can be used by project managers to systematically capture and articulate various business and project discussions into structured documents such as MOMs, call summaries, and RAID (Risks, Assumptions, Issues, and Dependencies) logs. Further, the artifact generation platform can be used by quality analysts to produce testing documentation such as test summaries, test scenarios, and acceptance criteria documents.

As another example, the artifact generation platform can be used in the context of customer support teams to create detailed support case documentation and knowledge base articles. Customer support representatives may handle numerous interactions with customers that require them to document issues, resolutions, and follow-up actions. The artifact generation platform can automatically transcribe customer calls, chat logs, and email exchanges, extracting pertinent information to generate comprehensive support case documents and knowledge base articles. The artifact generation platform can identify key elements such as problem descriptions, troubleshooting steps, and resolution details. The artifact generation platform can categorize and tag the information based on predefined taxonomies, making it easier to search and retrieve relevant documents. For example, a support case involving a software bug can be tagged under “Software Issues” and “High Severity,” enabling support teams to quickly locate, filter, and/or reference similar cases. In some implementations, the artifact generation platform integrates with customer relationship management (CRM) systems to automatically update case statuses and link related documentation.

As yet another example, the artifact generation platform can be used to create regulatory compliance documentation for organizations such as financial institutions. For example, financial institutions are required to adhere to regulatory standards and regularly produce audit reports and documentation to demonstrate compliance. The artifact generation platform can automatically process various data sources, including transaction records, audit logs, and communication transcripts, to generate the compliance reports. The artifact generation platform can identify and extract relevant information such as transaction anomalies, compliance breaches, and audit trails. The artifact generation platform can categorize and tag the information based on regulatory requirements, such as anti-money laundering (AML) and know your customer (KYC) guidelines, making it easier to compile and review compliance documents. For example, a suspicious transaction report can be tagged under “AML Compliance” and “High Risk,” enabling users to quickly identify and address potential issues. Additionally, the artifact generation platform can integrate with existing compliance management systems to ensure that all documentation is up-to-date and easily accessible for audits and regulatory reviews.

In some aspects, the techniques described herein relate to a computer-implemented method for automatically identifying content used to generate project artifacts from transcripts and audiovisual files, the computer-implemented method including: processing a set of video frames to generate a set of tokens for a project artifact; using a graphical user interface (GUI), capturing an output type instruction, wherein the output type instruction is indicative of a specific output type of the project artifact, wherein the specific output type includes one or more of: a call summary, meeting minutes, a user story, a test case, a business requirements document, or process steps; using the output type instruction and the generated set of tokens, causing a trained neural network to generate the project artifact according to: (i) the specific output type and (ii) at least two of: a project type, a user role, a domain, or a technology stack descriptor, wherein the project artifact comprises a body of text; causing the GUI to display: (i) a first component comprising the generated project artifact and (ii) a second component comprising a chat bot having a context for the chat bot set to the generated project artifact; responsive to detecting a user query at the GUI, causing the chat bot to search the generated project artifact displayed in the first component using the detected user query to generate a set of search results; and displaying the generated set of search results at the second component of the GUI.

In some aspects, the techniques described herein relate to a computer-implemented method, further including: detecting a start frame and an end frame in the set of video frames; using a subset of frames between and including the start frame and the end frame, generating a transcript token and a context token; and including the transcript token in the set of tokens.

In some aspects, the techniques described herein relate to a computer-implemented method, wherein the context token includes a relevance score that corresponds to the transcript token, and wherein the relevance score is indicative of a relevance level of the transcript token with at least one or more of: the specific output type, the project type, the user role, the domain, or the technology stack descriptor.

In some aspects, the techniques described herein relate to a computer-implemented method, wherein the relevance score is calculated at least in part based on the user role, the computer-implemented method further including: determining the user role in connection with identifying a speaker using the transcript token or metadata associated with the transcript token.

In some aspects, the techniques described herein relate to a computer-implemented method, wherein the relevance score is associated at least in part based on frame metadata, wherein the frame metadata corresponds to one or more of: the set of video frames or transcript token metadata.

In some aspects, the techniques described herein relate to a computer-implemented method, further including: generating a sensitivity indicator using the transcript token or metadata associated with the transcript token; and based on a determination that the sensitivity indicator exceeds a predetermined threshold, causing the transcript token to be omitted from the context for the chat bot.

In some aspects, the techniques described herein relate to a computer-implemented method, wherein the generated project artifact is a first observed project artifact, further including: receiving a set of user input including attributes of an expected project artifact of the output type instruction, wherein the set of user input indicates one or more of: a relevance metric, an accuracy metric, or a completeness metric of the first observed project artifact; and incrementally adjusting parameters of the trained neural network using the set of user input, wherein the trained neural network is configured to use the adjusted parameters to generate a second observed project artifact including the attributes of the expected project artifact.

In some aspects, the techniques described herein relate to one or more non-transitory, computer-readable storage media storing instructions for generating project artifacts, wherein the instructions when executed by at least one data processor of a computing system, cause the computing system to: process a set of audiovisual files to generate a set of tokens for a project artifact; using a graphical user interface (GUI), capture an output type instruction indicative of a specific output type of the project artifact, wherein the specific output type includes one or more of: a call summary, meeting minutes, a user story, a test case, a business requirements document, or process steps; using the output type instruction and the generated set of tokens, cause a trained neural network to generate the project artifact according to: (i) the specific output type and (ii) at least one of: a project type, a user role, a domain, or a technology stack descriptor, wherein the project artifact comprises a body of text; cause the GUI to display: (i) a first component comprising the generated project artifact and (ii) a second component comprising a chat bot having a context for the chat bot set to the generated project artifact; responsive to detecting a user query at the GUI, cause the chat bot to search the generated project artifact displayed in the first component using the detected user query to generate a set of search results; and display the generated set of search results at the second component of the GUI.

In some aspects, the techniques described herein relate to one or more non-transitory, computer-readable storage media, wherein the instructions further cause the computing system to: detect a start frame and an end frame in a set of video frames within the set of audiovisual files; using a subset of frames between and including the start frame and the end frame, generate a transcript token and a context token; and include the transcript token in the set of tokens.

In some aspects, the techniques described herein relate to one or more non-transitory, computer-readable storage media, wherein the context token includes a relevance score that corresponds to the transcript token, and wherein the relevance score is indicative of a relevance level of the transcript token with at least one or more of: the specific output type, the project type, the user role, the domain, or the technology stack descriptor.

In some aspects, the techniques described herein relate to one or more non-transitory, computer-readable storage media, wherein the set of audiovisual files is a first set of files, wherein the instructions further cause the computing system to: generate a first set of operative standards within the first set of files, wherein each operative standard in the first set of operative standards is configured to satisfy constraints of the first set of files; provide a second set of operative standards of a second set of files; and identify a set of gaps by comparing the first set of operative standards with the second set of operative standards, wherein the set of gaps include actions present in the second set of operative standards and absent in the first set of operative standards.

In some aspects, the techniques described herein relate to one or more non-transitory, computer-readable storage media, wherein the instructions further cause the computing system to: automatically trigger one or more alarms in response to the identified set of gaps satisfying a set of predetermined criteria.

In some aspects, the techniques described herein relate to one or more non-transitory, computer-readable storage media, wherein the instructions further cause the computing system to: generate a sensitivity indicator using the transcript token or metadata associated with the transcript token; and based on a determination that the sensitivity indicator exceeds a predetermined threshold, cause the transcript token to be omitted from the context for the chat bot.

In some aspects, the techniques described herein relate to one or more non-transitory, computer-readable storage media, wherein the generated project artifact is a first observed project artifact, wherein the instructions further cause the computing system to: receive a set of user input including attributes of an expected project artifact of the output type instruction, wherein the set of user input indicates one or more of: a relevance metric, an accuracy metric, or a completeness metric of the first observed project artifact; and incrementally adjust parameters of the trained neural network using the set of user input, wherein the trained neural network is configured to use the adjusted parameters to generate a second observed project artifact including the attributes of the expected project artifact.

In some aspects, the techniques described herein relate to a system including: at least one hardware processor; and at least one non-transitory memory storing instructions, which, when executed by the at least one hardware processor, cause the system to: receive a set of files including at least one of: a transcript, a video recording, an audio recording, or an audiovisual recording; using the set of files, generate a set of tokens for a project artifact; using a graphical user interface (GUI), capture an output type instruction indicative of a specific output type of the project artifact; using the output type instruction and the generated set of tokens, cause a trained neural network to generate the project artifact according to: (i) the specific output type and (ii) at least one of: a project type, a user role, a domain, or a technology stack descriptor; cause the GUI to display: (i) a first component comprising the generated project artifact and (ii) a second component comprising a chat bot having a context for the chat bot set to the generated project artifact; responsive to detecting a user query at the GUI, cause the chat bot to search the generated project artifact displayed in the first component using the detected user query to generate a set of search results; and display the generated set of search results at the second component of the GUI.

In some aspects, the techniques described herein relate to a system, wherein the system is further caused to: detect a start frame and an end frame in a set of video frames within the set of files; using a subset of frames between and including the start frame and the end frame, generate a transcript token and a context token; and include the transcript token in the set of tokens.

In some aspects, the techniques described herein relate to a system, wherein the context token includes a relevance score that corresponds to the transcript token, and wherein the relevance score is indicative of a relevance level of the transcript token with at least one or more of: the specific output type, the project type, the user role, the domain, or the technology stack descriptor.

In some aspects, the techniques described herein relate to a system, wherein the relevance score is calculated at least in part based on the user role, wherein the system is further caused to: determine the user role in connection with identifying a speaker using the transcript token or metadata associated with the transcript token.

In some aspects, the techniques described herein relate to a system, wherein the system is further caused to: generate a sensitivity indicator using the transcript token or metadata associated with the transcript token; and based on a determination that the sensitivity indicator exceeds a predetermined threshold, cause the transcript token to be omitted from the context for the chat bot.

In some aspects, the techniques described herein relate to a system, wherein the generated project artifact is a first observed project artifact, wherein the system is further caused to: receive a set of user input including attributes of an expected project artifact of the output type instruction, wherein the set of user input indicates one or more of: a relevance metric, an accuracy metric, or a completeness metric of the first observed project artifact; and incrementally adjust parameters of the trained neural network using the set of user input, wherein the trained neural network is configured to use the adjusted parameters to generate a second observed project artifact including the attributes of the expected project artifact.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A computer-implemented method for automatically identifying content used to generate project artifacts from transcripts and audiovisual files, the computer-implemented method comprising:
processing a set of video frames to generate a set of tokens for a project artifact;
using a graphical user interface (GUI), capturing an output type instruction indicative of a specific output type of the project artifact,
wherein the specific output type includes one or more of: a call summary, meeting minutes, a user story, a test case, a business requirements document, or process steps;
using the output type instruction and the generated set of tokens, causing a trained neural network to generate the project artifact according to: (i) the specific output type and (ii) at least two of: a project type, a user role, a domain, or a technology stack descriptor,
wherein the project artifact comprises a body of text;
causing the GUI to display: (i) a first component comprising the generated project artifact and (ii) a second component comprising a chat bot having a context for the chat bot set to the generated project artifact;
responsive to detecting a user query at the GUI, causing the chat bot to search the generated project artifact displayed in the first component using the detected user query to generate a set of search results; and
displaying the generated set of search results at the second component of the GUI.

2. The computer-implemented method of claim 1, further comprising:
detecting a start frame and an end frame in the set of video frames;
using a subset of frames between and including the start frame and the end frame, generating a transcript token and a context token; and
including the transcript token in the set of tokens.

3. The computer-implemented method of claim 2,
wherein the context token comprises a relevance score that corresponds to the transcript token, and
wherein the relevance score is indicative of a relevance level of the transcript token with at least one or more of: the specific output type, the project type, the user role, the domain, or the technology stack descriptor.

4. The computer-implemented method of claim 3, wherein the relevance score is calculated at least in part based on the user role, the computer-implemented method further comprising:
determining the user role in connection with identifying a speaker using the transcript token or metadata associated with the transcript token.

5. The computer-implemented method of claim 3,
wherein the relevance score is associated at least in part based on frame metadata,
wherein the frame metadata corresponds to one or more of: the set of video frames or transcript token metadata.

6. The computer-implemented method of claim 2, further comprising:
generating a sensitivity indicator using the transcript token or metadata associated with the transcript token; and
based on a determination that the sensitivity indicator exceeds a predetermined threshold, causing the transcript token to be omitted from the context for the chat bot.

7. The computer-implemented method of claim 1, wherein the generated project artifact is a first observed project artifact, further comprising:
receiving a set of user input comprising attributes of an expected project artifact of the output type instruction,
wherein the set of user input indicates one or more of: a relevance metric, an accuracy metric, or a completeness metric of the first observed project artifact; and
incrementally adjusting parameters of the trained neural network using the set of user input,
wherein the trained neural network is configured to use the adjusted parameters to generate a second observed project artifact comprising the attributes of the expected project artifact.

8. One or more non-transitory, computer-readable storage media storing instructions for generating project artifacts, wherein the instructions when executed by at least one data processor of a computing system, cause the computing system to:
process a set of audiovisual files to generate a set of tokens for a project artifact;
using a graphical user interface (GUI), capturing an output type instruction indicative of a specific output type of the project artifact,
wherein the specific output type includes one or more of: a call summary, meeting minutes, a user story, a test case, a business requirements document, or process steps;
using the output type instruction and the generated set of tokens, cause a trained neural network to generate the project artifact according to: (i) the specific output type and (ii) at least one of: a project type, a user role, a domain, or a technology stack descriptor,
wherein the project artifact comprises a body of text;
cause the GUI to display: (i) a first component comprising the generated project artifact and (ii) a second component comprising a chat bot having a context for the chat bot set to the generated project artifact;
responsive to detecting a user query at the GUI, cause the chat bot to search the generated project artifact displayed in the first component using the detected user query to generate a set of search results; and
display the generated set of search results at the second component of the GUI.

9. The one or more non-transitory, computer-readable storage media of claim 8, wherein the instructions further cause the computing system to:
detect a start frame and an end frame in a set of video frames within the set of audiovisual files;
using a subset of frames between and including the start frame and the end frame, generate a transcript token and a context token; and
include the transcript token in the set of tokens.

10. The one or more non-transitory, computer-readable storage media of claim 9,
wherein the context token comprises a relevance score that corresponds to the transcript token, and
wherein the relevance score is indicative of a relevance level of the transcript token with at least one or more of: the specific output type, the project type, the user role, the domain, or the technology stack descriptor.

11. The one or more non-transitory, computer-readable storage media of claim 8, wherein the set of audiovisual files is a first set of files, wherein the instructions further cause the computing system to:
generate a first set of operative standards within the first set of files,
wherein each operative standard in the first set of operative standards is configured to satisfy constraints of the first set of files;
provide a second set of operative standards of a second set of files; and
identify a set of gaps by comparing the first set of operative standards with the second set of operative standards,
wherein the set of gaps include actions present in the second set of operative standards and absent in the first set of operative standards.

12. The one or more non-transitory, computer-readable storage media of claim 11, wherein the instructions further cause the computing system to:
automatically trigger one or more alarms in response to the identified set of gaps satisfying a set of predetermined criteria.

13. The one or more non-transitory, computer-readable storage media of claim 9, wherein the instructions further cause the computing system to:
generate a sensitivity indicator using the transcript token or metadata associated with the transcript token; and
based on a determination that the sensitivity indicator exceeds a predetermined threshold, cause the transcript token to be omitted from the context for the chat bot.

14. The one or more non-transitory, computer-readable storage media of claim 8, wherein the generated project artifact is a first observed project artifact, wherein the instructions further cause the computing system to:
receive a set of user input comprising attributes of an expected project artifact of the output type instruction,
wherein the set of user input indicates one or more of: a relevance metric, an accuracy metric, or a completeness metric of the first observed project artifact; and
incrementally adjust parameters of the trained neural network using the set of user input,
wherein the trained neural network is configured to use the adjusted parameters to generate a second observed project artifact comprising the attributes of the expected project artifact.

15. A system comprising:
at least one hardware processor; and
at least one non-transitory memory storing instructions, which, when executed by the at least one hardware processor, cause the system to:
receive a set of files including at least one of: a transcript, a video recording, an audio recording, or an audiovisual recording;
using the set of files, generate a set of tokens for a project artifact;
using a graphical user interface (GUI), capturing an output type instruction indicative of a specific output type of the project artifact;
using the output type instruction and the generated set of tokens, cause a trained neural network to generate the project artifact according to: (i) the specific output type and (ii) at least one of: a project type, a user role, a domain, or a technology stack descriptor;
cause the GUI to display: (i) a first component comprising the generated project artifact and (ii) a second component comprising a chat bot having a context for the chat bot set to the generated project artifact;
responsive to detecting a user query at the GUI, cause the chat bot to search the generated project artifact displayed in the first component using the detected user query to generate a set of search results; and
display the generated set of search results at the second component of the GUI.

16. The system of claim 15, wherein the system is further caused to:
detect a start frame and an end frame in a set of video frames within the set of files;
using a subset of frames between and including the start frame and the end frame, generate a transcript token and a context token; and
include the transcript token in the set of tokens.

17. The system of claim 16,
wherein the context token comprises a relevance score that corresponds to the transcript token, and
wherein the relevance score is indicative of a relevance level of the transcript token with at least one or more of: the specific output type, the project type, the user role, the domain, or the technology stack descriptor.

18. The system of claim 17, wherein the relevance score is calculated at least in part based on the user role, wherein the system is further caused to:
determine the user role in connection with identifying a speaker using the transcript token or metadata associated with the transcript token.

19. The system of claim 16, wherein the system is further caused to:
generate a sensitivity indicator using the transcript token or metadata associated with the transcript token; and
based on a determination that the sensitivity indicator exceeds a predetermined threshold, cause the transcript token to be omitted from the context for the chat bot.

20. The system of claim 15, wherein the generated project artifact is a first observed project artifact, wherein the system is further caused to:
receive a set of user input comprising attributes of an expected project artifact of the output type instruction,
wherein the set of user input indicates one or more of: a relevance metric, an accuracy metric, or a completeness metric of the first observed project artifact; and
incrementally adjust parameters of the trained neural network using the set of user input,
wherein the trained neural network is configured to use the adjusted parameters to generate a second observed project artifact comprising the attributes of the expected project artifact.
